(19) United States
(12) Patent Application Publication
(10) Pub. No.: US 2008/0097048 A1
(43) Pub. Date: Apr. 24, 2008

(54) Cable Jacket Material And Cable Jacket

(75) Inventors: Tsuyoshi Ono, Osaka (JP); Haruhisa Masuda, Osaka (JP)

Correspondence Address: SUGHRUE MION, PLLC, 2100 PENNSYLVANIA AVENUE, N.W., SUITE 800, WASHINGTON, DC, 20037, US

(73) Assignee: Daikin Industries, Ltd, Osaka (JP)

(21) Appl. No.: 11/661,690

(22) PCT Filed: Sep. 5, 2005
(86) PCT No.: PCT/JP05/16273

§ 371 Date: Mar. 2, 2007

(30) Foreign Application Priority Data
Sep. 3, 2004 (JP) 2004-257716
Dec. 16, 2004 (JP) 2004-364286

(51) Int. Cl. C08G 61/00

(52) U.S. Cl. 525/539; 528/401

(57) ABSTRACT

The present invention provides a material for cable jackets which is excellent in flame retardancy and improved in processing or processed ability and flexibility as well as cable jackets made of such material. The present invention is a material for cable jackets comprising a fluororesin (A), wherein said fluororesin (A) shows a melting point at a temperature exceeding 180° C. but not higher than 245° C.

### TECHNICAL FIELD

The present invention relates to a material for cable jackets, to cable jackets and to cables for LANs.

### BACKGROUND ART

Cables for LANs each generally comprises a bundle of a plurality of copper wires covered with an insulating material comprising a fluororesin or the like as contained in a resin-made tube called “cable jacket” mainly for the purpose of providing them with flame retardancy.

Poly(vinyl chloride) has so far been used as a material for cable jackets. However, poly(vinyl chloride) has a problem in that it cannot satisfactorily meet the nowadays-growing demand for improved flame retardancy.

Cable jackets having an outer jacket made of poly(vinylidene fluoride) [PVdF] have also been proposed (cf. e.g. Patent Document 1). Disadvantageously, however, they are insufficient in flame retardancy.

Tetrafluoroethylene/hexafluoropropylene copolymers [FEPs] have come into use for the purpose of flame retardancy improvement. However, the FEPs so far in use have a high melting point and are disadvantageously poor in processing or processed ability and flexibility.

Binary copolymers derived from tetrafluoroethylene and hexafluoropropylene (cf. e.g. Patent Document 2) and ternary copolymers resulting from copolymerization thereof with a perfluoro(alkyl vinyl ether) as a modifier (cf. e.g. Patent Document 3 and Patent Document 4) have also been proposed as low-melting FEP species. However, the use of such low-melting FEPs in making cable jackets is not known in the art.

[Patent Document 1] Japanese Kohyo Publication S60-501925

[Patent Document 2] International Publication WO 94/05712

[Patent Document 3] International Publication WO 95/14791

[Patent Document 4] U.S. Pat. No. 5,677,404

### DISCLOSURE OF INVENTION

### Problems which the Invention is to Solve

In view of the above-discussed state of the art, it is an object of the present invention to provide a material for cable jackets which is excellent in flame retardancy and improved in processing or processed ability and flexibility as well as cable jackets made of such material.

### Means for Solving the Problems

The present invention provides a material for cable jackets comprising a fluororesin (A), wherein the above-mentioned fluororesin (A) shows a melting point at a temperature exceeding 180° C. but not higher than 245° C.

The invention further provides a cable jacket obtained by molding the above-defined material for cable jackets.

The invention still further provides a cable for LAN having the above-mentioned cable jacket.

In the following, the invention is described in detail.

The material for cable jackets according to the invention comprises a fluororesin (A).

The fluororesin (A) comprises a fluorine-containing polymer obtained by polymerizing a fluorine-containing monomer or monomers.

The fluororesin (A) may comprise one single or two or more fluorine-containing polymer species.

The fluororesin (A) is not particularly restricted but may be, for example, any of those having a melting point within the range mentioned later herein, including fluorine-containing polymers obtained by polymerizing one single or two or more fluorine-containing monomer species selected from the fluorine-containing monomer group consisting of chlorotrifluoroethylene [CTFE], trifluoroethylene, tetrafluoroethylene [TFE], hexafluoropropylene [HFP], vinylidene fluoride [VdF], perfluoro(alkyl vinyl ether) species [PAVEs] and the like. The fluorine-containing polymers may further include those obtained by copolymerizing one or more fluorine-containing monomers and one or more fluorine-free monomers selected from the fluorine-free monomer group consisting of ethylene [Et], propylene and so forth.

Copolymers comprising TFE and one or more monomers copolymerizable with TFE are preferred as the fluorine-containing polymers mentioned above.

Preferred as the “monomers copolymerizable with TFE” are HFP and PAVEs and, as the PAVEs, there may be mentioned perfluoro(methyl vinyl ether) [PMVE], perfluoro(ethyl vinyl ether) [PEVE] and perfluoro(propyl vinyl ether) [PPVE]. Thus, the copolymers comprising TFE and a monomer or monomers copolymerizable with TFE may be copolymers comprising TFE and HFP, copolymer comprising TFE, HFP and a PAVE or PAVEs, or copolymers comprising TFE and a PAVE or PAVEs.

As the copolymers comprising TFE and a monomer or monomers copolymerizable with TFE, which fall within the category of the fluororesin (A), there may more specifically be mentioned, for example, TFE/HFP copolymers [FEPs], TFE/HFP/PAVE copolymers, TFE/PAVE copolymers, Et/TFE/HFP copolymers [EFEPs], and TFE/HFP/VdF copolymers [THVs]. Among them, copolymers comprising TFE and HFP, copolymers comprising TFE, HFP and a PAVE or PAVEs, and copolymers comprising TFE and a PAVE or PAVEs are preferred.

The above-mentioned “TFE/HFP copolymers” or “copolymers comprising TFE and HFP” may respectively be copolymers derived from TFE and HFP alone, or copolymers comprising TFE and HFP and, further, one or more monomers copolymerizable with TFE and HFP unless the characteristics of the copolymers derived from TFE and HFP alone are deteriorated by such monomers. Like the copolymers enumerated above, the above-mentioned “TFE/HFP/PAVE copolymers”, “copolymers comprising TFE, HFP and a PAVE or PAVEs”, “TFE/PAVE copolymers” and “copolymers comprising TFE and a PAVE or PAVEs” may also be copolymers derived from the specified monomers alone or copolymers comprising those monomers and one or more monomers copolymerizable therewith.

TFE/HFP/PPVE copolymers are preferred as the above TFE/HFP/PAVE copolymers.

The material for cable jackets according to the invention in which one of the above-mentioned fluorine-containing copolymers is used as the fluororesin (A) can improve the flexibility of the resulting cable jackets. The cause of this improvement in flexibility is not clear but, when the fluororesin (A) is a FEP, for instance, it may be presumed that its low melting point, as mentioned above, and its relatively high HFP unit content, hence its high amorphous character, make contributions to that improvement.

The fluororesin (A) shows a melting point at a temperature exceeding 180° C. but not higher than 245° C.

A preferred lower limit to the above melting point is 195° C., a more preferred lower limit is 210° C., a preferred upper limit is 240° C., and a more preferred upper limit is 235° C.

The material for cable jackets according to the invention, which comprises the fluororesin (A) having such a low melting point as falls within the range mentioned above, has good flame retardancy and can show improved processing or processed ability.

The material for cable jackets, even when another material or other materials, for example a soft resin (B) to be mentioned later herein, is/are incorporated therein, comprises the fluororesin (A) having such a low melting point that falls within the range mentioned above.

The “melting point” so referred to herein is the temperature corresponding to the heat-of-melting peak in the crystal melting curve obtained by using a differential scanning calorimeter [DSC] (RDC-220, product of SII NanoTechnology Inc.) and raising the temperature at a rate of 10° C./minute.

The fluororesin (A) can be appropriately prepared by carrying out the polymerization in the conventional manner, for example in the manner of emulsion polymerization or suspension polymerization, followed by concentration, coagulation, drying and so forth in the conventional manner.

The material for cable jackets according to the invention may further mixed with a soft resin (B) as well as the fluororesin (A).

When it further mixed with the soft resin (B) as well as the fluororesin (A), the material for cable jackets of the invention can give moldings particularly excellent in resiliency or flexibility and further enables cost reductions owing to the reduction in the amount of the fluororesin which is generally expensive.

The “soft resin (B)” so referred to herein is a polymer which, when incorporated in the material for cable jackets, provides the moldings produced therefrom with a higher level of resiliency or flexibility as compared with the case of nonuse of such resin.

The term “soft resin (B)” as used herein contains the word “resin” for convenience sake but includes, within the meaning thereof, not only resins but also rubbers.

For improving the resiliency or flexibility of the moldings to be obtained, the soft resin (B) preferably has an elastic modulus of not higher than 100 MPa and, so long as it is within such range, the elastic modulus of the soft resin (B) may be, for example, 0.1 MPa or higher. A more preferred upper limit to the elastic modulus of the soft resin (B) is 50 MPa, and a preferred lower limit is 0.5 MPa.

Such elastic modulus values are the values obtained by carrying out measurements on a viscoelastometer (RSA-2, product of Rheometrics) using samples (1 mm thick×5 mm wide×22.5 mm long) under room temperature conditions at a frequency of 3.3 Hz.

The soft resin (B) to be used in the material for cable jackets of the invention is not particularly restricted provided that it has the above characteristic. Thus, mention may be made of silicone rubbers, fluororubbers, and poly(vinyl chloride) species, for instance.

As the silicone rubbers, there may be mentioned methylsilicone rubbers, vinylmethylsilicone rubbers, phenylmethylsilicone rubbers, phenylvinylmethylsilicone rubbers, fluorosilicone rubbers, etc.

The fluororubbers are not particularly restricted but include, among others, VdF/HFP copolymers, VdF/HFP/TFE copolymers, VdF/chlorotrifluoroethylene [CTFE] copolymers, TFE/propylene copolymers, HFP/ethylene copolymers, PAVE/olefin copolymers, fluorosilicone rubbers and fluorophosphazene rubbers. VdF/HFP copolymers are preferred, however.

The poly(vinyl chloride) [PVC] species may be homopolymers comprising vinyl chloride, or copolymers comprising vinyl chloride and another monomer or other monomers, or plasticized poly(vinyl chloride) species obtained by further incorporation of a plasticizer(s) and/or the like.

As the other monomers mentioned above, there may be mentioned, among others, α-olefins such as ethylene and propylene; vinyl compounds such as vinyl acetate, acrylate esters, alkyl vinyl ethers, vinyl bromide, vinyl fluoride, styrene and acrylonitrile; and vinylidene compounds such as vinylidene chloride.

As for the PVC species, plasticized poly(vinyl chloride) species are preferred from the processing or processed ability viewpoint.

The plasticized poly(vinyl chloride) species are generally PVC species obtained by polymerizing vinyl chloride with a softening agent incorporated therein, and the moldings produced therefrom show a tensile elongation at break of at least 180%.

As the plasticized poly(vinyl chloride) species, there may be mentioned, for example, those described in Japanese Kokai Publication H07-292195.

The other rubbers are not particularly restricted but include, among others, polybutadiene, polyisoprene, polychloroprene, nitrile rubbers [NBRs], styrene-butadiene rubbers [SBRs], ethylene-butadiene rubbers [EPRs] and ethylene-propylene-diene rubbers [EPDMs].

In the material for cable jackets of the invention, the soft resin (B) may comprise either one single species or two or more species.

From the flame retardancy viewpoint, among others, the soft resin (B) is preferably a silicone rubber, a fluororubber and/or a poly(vinyl chloride) species.

The phrase “a silicone rubber, a fluororubber and/or a poly(vinyl chloride) species” as used herein includes, within the meaning thereof, out of these three kinds, a silicone rubber alone, a fluororubber alone, a poly(vinyl chloride) species alone, a silicone rubber plus a fluororubber, a silicone rubber plus a poly(vinyl chloride) species, a fluororubber plus a poly(vinyl chloride) species, and a silicone rubber plus a fluororubber plus a poly(vinyl chloride) species. The silicone rubber may comprise either one single species or two or more species and, as for the fluororubber and poly(vinyl chloride) species, each may also comprise either one single species or two or more species.

The silicone rubber, fluororubber and/or poly(vinyl chloride) species to be used as the soft resin (B) may be a crosslinkable rubber.

When it comprises the soft resin (B) as well as the fluororesin (A), the material for cable jackets of the invention generally has a sea-island structure (domain structure with isolated domains).

The material for cable jackets according to the invention, which has such sea-island structure, can be improved in processing or processed ability/workability while retaining the flame retardancy which the fluororesin (A) has.

From the flame retardancy viewpoint, the sea-island structure is preferably the one comprising the fluororesin (A) as the sea component and the soft resin (B) as the island component (isolated domains).

The soft resin (B) serving as the island component in the above sea-island structure preferably has a particle diameter within the range of 0.1 to 30 μm, more preferably within the range of 0.3 to 10 μm.

The soft resin (B) preferably accounts for 1 to 70% by mass of the total mass of the fluororesin (A) and soft resin (B).

When the proportions of the fluororesin (A) and soft resin (B) are in such a range as mentioned above, there is a tendency for the material for cable jackets of the invention to readily have the above-mentioned sea-island structure.

A more preferred lower limit to the proportion of the soft resin (B) relative to the total mass of the fluororesin (A) and soft resin (B) is 5% by mass, a more preferred upper limit is 40% by mass and, from the flame retardancy viewpoint, a still more preferred upper limit is 30% by mass.

The material for cable jackets according to the invention may comprises a flame retardant.

Even if a material rather poor in flame retardancy, for example an olefin rubber, is used as the soft resin (B), the material for cable jackets of the invention which further comprises a flame retardant can give flame retardancy-maintaining cable jackets.

The flame retardant is not particularly restricted but includes, among others, magnesium oxide, metal hydroxides such as aluminum hydroxide; phosphate type flame retardants; bromide type flame retardants, chloride type flame retardants and other halide type flame retardants. Among them, metal hydroxides and phosphate type flame retardants are preferred.

The flame retardant content in the material for cable jackets of the invention is not particularly restricted but preferably is 1 to 70 parts by mass per 100 parts by mass of the fluororesin (A) or, when the material further comprises the soft resin (B), per 100 parts by mass of the sum of the fluororesin (A) and soft resin (B). When it is less than 1 part by mass, the addition of the flame retardant will produce no particular flame retardancy improving effect and, when it exceeds 70 parts by mass, the processing or processed ability and the flexibility of the cable jackets obtained may be poor in some instances. A more preferred lower limit to the flame retardant content is 5 parts by mass, and a more preferred upper limit is 50 parts by mass.

The material for cable jackets according to the invention may further comprise, in addition to the fluororesin (A), soft resin (B) and flame retardant, one or more additives selected from among stabilizers, ultraviolet absorbers, light stabilizers, antistatic agents, nucleating agents, lubricants, fillers, dispersants, metal deactivators, neutralizing agents, processing aids, mold release agents, blowing agents, colorants and the like as incorporated therein at addition levels at which they will not adversely affect such properties of the material as flame retardancy and processing or processed ability.

The material for cable jackets according to the invention may be the one obtained by compounding the fluororesin (A) with the soft resin (B) by melt-blending, for instance, for the purpose of providing the fluororesin (A) with further flexibility. The melt-blending technique is not particularly restricted but may be any of the techniques known in the art. There may be mentioned, for example, the method comprising mixing the fluororesin (A) and soft resin (B) together at a temperature at which both resins melt (e.g. 180 to 310° C.) using a twin-screw extruder.

The melt-blending mentioned above may also be realized using a single-screw extruder, a Banbury mixer, a mixing roll or a like apparatus.

When a crosslinkable rubber is used as the soft resin (B), the material for cable jackets of the invention can also be produced by the so-called dynamic crosslinking method which comprises carrying out the melt-blending in the presence of a crosslinking agent (D) to thereby cause the soft resin (B) to be crosslinked simultaneously with the mixing of the fluororesin (A) with the soft resin (B).

The material for cable jackets according to the invention can also be produced by mixing fine particles prepared from the soft resin (B) crosslinked in advance with the fluororesin (A) by the above melt-blending technique.

The crosslinking agent (D) is not particularly restricted but use can be made of organic peroxides, amine compounds, polyol compounds, sulfur compounds and phenolic compounds, among others. In the above-mentioned dynamic crosslinking, the crosslinking agent (D) or the like can be used at addition levels suitably selected within such a range that the properties of the material for cable jackets may not be adversely affected.

Preferred as the material for cable jackets of the invention are those produced by the above-mentioned melt-blending so as to form a sea-island structure comprising the fluororesin (A) as the sea component and the soft resin (B) as the island component since such ones are excellent in flame retardancy and processing or processed ability.

The material for cable jackets according to the invention can be obtained in the form of pellets or a powder, for instance. The pellet form is preferred since pellets can be molded by extrusion with ease.

The pellets can be prepared by carrying out the melt-blending mentioned above.

The material for cable jackets according to the invention, which has the constitution described above, is excellent in processing or processed ability and heat stability and, in addition, in flexibility.

The material for cable jackets according to the invention preferably shows an elastic modulus (modulus of elasticity) in bending of 100 to 700 MPa.

A preferred lower limit to the elastic modulus in bending is 150 MPa, a more preferred lower limit is 200 MPa, a preferred upper limit is 600 MPa, and a more preferred upper limit is 500 MPa.

The “elastic modulus in bending” so referred to herein indicates the value measured at room temperature according to ASTM D 790 using a Tensilon universal testing machine (UTC-500, product of Orientec).

The material for cable jackets according to the invention, which has the above constitution, is excellent in processing or processed ability and flexibility and shows particularly excellent heat resistance, hence can be properly used as a molding material for the production of LCC (Limited Combustible Cable) jackets which are required to have a higher level of flame retardancy than in the conventional art.

A cable jacket formed by molding the material for cable jackets of the invention also constitutes one aspect of the present invention.

The above-mentioned cable jacket is generally a tubular body for housing copper wires and coverings thereof to give a wire or cable for use in an electronic device such as a computer for the purpose of providing it with flame retardancy and protecting it from mechanical damage, among others.

The method of molding using the material for cable jackets of the invention is not particularly restricted but may be any of the conventional methods, for example the method of molding by extrusion using a crosshead and a single-screw extruder.

The cable jacket of the invention may have a thickness properly selected according to the intended use and other factors. Generally, it has a thickness within the range of 0.2 to 1.0 mm.

The cable jacket of the invention, which has a thickness within the above range, is particularly excellent in flexibility.

The cable jacket of the invention, which is the one obtained by molding the material for cable jackets of the invention, is excellent in flame retardancy and flexibility, among others.

The use of the cable jacket of the invention is not particularly restricted but the jacket can be used, for example, in a cable for wiring with an electronic device, in a 600 V insulated cable, or in a telecommunication cable such as a LAN cable. The LAN cable is a cable for LAN.

The cable for LAN having the cable jacket of the invention also constitutes a further aspect of the invention.

The cable for LAN is, for example, a plenum cable and, further, it is suited for use as the above-mentioned LCC.

The cable for LAN of the invention may have an appropriately selected jacket thickness. Generally, the jacket is molded so that it may have a thickness of 0.2 to 1.0 mm.

The cable for LAN of the invention, which is having the cable jacket of the invention, is excellent in flame retardancy and flexibility, among others.

### EFFECTS OF THE INVENTION

The material for cable jackets according to the invention, which has the constitution described above, shows good processing or processed ability and can form cable jackets excellent in flexibility without any substantial deterioration of the flame retardancy which is shown by the cable jacket made of the conventional high-melting FEP alone.

The cable for LAN of the invention, which is having the cable jacket mentioned above, is excellent in flame retardancy and flexibility.

### BEST MODES FOR CARRYING OUT THE INVENTION

The following examples and comparative examples illustrate the present invention in further detail. These examples and comparative examples are, however, by no means limitative of the scope of the invention.

In the examples and comparative examples, the following fluororesins (A), soft resins (B) and fluororesin (C) were used.

<Fluororesins (A)>

A-1: Tetrafluoroethylene/hexafluoropropylene copolymer [FEP] (pellets, melting point: 210° C.)

A-2: Tetrafluoroethylene/hexafluoropropylene/perfluoro(propyl vinyl ether) copolymer (pellets, melting point: 210° C.)

A-3: Tetrafluoroethylene/perfluoro(methyl vinyl ether) copolymer (pellets, melting point: 200° C.)

<Soft Resins (B)>

B-1: Silicone rubber (trademark: E-600, product of Dow Corning Toray Silicone)

B-2: Fluororubber (trademark: DAI-EL G-701, product of Daikin Industries)

B-3: Plasticized poly(vinyl chloride) (trademark: SL-C, product of Chisso Corporation)

<Fluororesin (C)>

FEP (pellets, melting point: 260° C.)

The melting point reported of each of the fluororesins (A) and fluororesin (C) is the temperature corresponding to the heat-of-melting peak in the crystal melting curve obtained by using a differential scanning calorimeter [DSC] (RDC-220, product of SII NanoTechnology) and raising the temperature at a rate of 10° C./minute.

In each of the examples and comparative examples, the measurements were carried out by the following methods.

(1) Test Specimen Preparation

Test specimens (according to ASTM D-790) for elastic modulus in bending measurement and test specimens (length×width×thickness=80 mm×10 mm×1.5 mm) for flame retardancy evaluation were prepared from the pellets of the “material for cable jackets” as produced in the examples and comparative examples by one minute of heat compression at a molding temperature of 300° C. in the case of the fluororesin (A) or 360° C. in the case of the fluororesin (C) and at a molding pressure of 3.5 MPa, followed by 5 minutes of water cooling under pressure, using a compression molding press (Shinto Metal Industries model NF-37).

(2) Elastic Modulus in Bending Measurement

Using the above test specimens, elastic modulus in bending measurements were carried out on a Tensilon universal testing machine (UTC-500, ORIENTEC) at room temperature according to ASTM D 790.

(3) Flame Retardancy Evaluation

One end of each test specimen prepared as mentioned above was brought into contact with the flame of a gas burner for 5 minutes, and the condition of the test specimen was judged according to the following criteria.

A: No ignition, thin smoke;

B: No ignition, thick smoke;

C: Ignition.

(4) Processing or Processed Ability Evaluation

Using the pellets of each of the “materials for cable jackets”, cable jacketing was carried out using a 30 ø extruder (Tanabe Plastic Kikai's electric wire covering apparatus); the number of screw revolutions was 10 rpm.

The jacket surface was observed by the eye, and the evaluation was made according to the following criteria.

A: Smooth and lustrous surface;

B: Smooth but lusterless surface;

C: Unsmooth surface.

### EXAMPLE 1

Test specimens were prepared from the fluororesin (A-1) by the method described above under (1) and subjected to elastic modulus in bending and flame retardancy evaluations. Further, the fluororesin (A-1) was evaluated for processing or processed ability by the method described above under (4) at a cylinder temperature of 300° C.

### EXAMPLES 2 TO 4

The fluororesin (A-1) was preliminarily blended with each of the soft resins (B) in the proportion shown in Table 1, the mixture was fed to a 40 ø twin-screw extruder (Plastic Kogaku Kenkyusho (PLABOR) model BT-40) and melt-blended, and pellets for cable jacketing were produced therefrom under the following conditions: cylinder temperature 300° C., number of screw revolutions 150 rpm. From the pellets obtained, test specimens were prepared by the method described above under (1) and evaluated for elastic modulus in bending and for flame retardancy. Further, the pellets obtained were evaluated for processing or processed ability by the method described above under (4) at a cylinder temperature of 300° C.

The results obtained in Examples 1 to 4 are shown in Table 1.

TABLE 1

| | Example 1 | Example 2 | Example 3 | Example 4 |
|---|---|---|---|---|
| Fluororesin (A-1) | 100 | 80 | 80 | 80 |
| Soft resin (B-1) | — | 20 | — | — |
| Soft resin (B-2) | — | — | 20 | — |
| Soft resin (B-3) | — | — | — | 20 |
| Elastic modulus in | 440 | 320 | 350 | 330 |
| bending (MPa) | | | | |
| Flame retardancy | A | A | A | A |
| Processing or | A | A | A | A |
| processed ability | | | | |

A-1: Tetrafluoroethylene/hexafluoropropylene copolymer (melting point: 210° C.)
B-1: E-600, product of Dow Corning Toray Silicone
B-2: DAI-EL G-701, product of Daikin Industries
B-3: SL-C, product of Chisso Corporation.

As shown in Table 1, the test specimens obtained in Examples 1 to 4 showed excellent elastic moduli in bending and flame retardancy in all the examples. Further, the pellets obtained in Examples 1 to 4 showed good processing or processed ability in all the examples.

### EXAMPLE 5

Test specimens were prepared from the fluororesin (A-2) by the method described above under (1) and subjected to elastic modulus in bending and flame retardancy evaluations. Further, the fluororesin (A-2) was evaluated for processing or processed ability by the method described above under (4) at a cylinder temperature of 300° C.

The fluororesin (A-2) was preliminarily blended with each of the soft resins (B) in the proportion shown in Table 2, and the mixture was melt-blended and pellets for cable jacketing were produced therefrom in the same manner as in Examples 2 to 4. From the pellets obtained, test specimens were prepared by the method described above under (1) and evaluated for elastic modulus in bending and for flame retardancy. Further, the pellets obtained were evaluated for processing or processed ability by the method described above under (4) at a cylinder temperature of 300° C.

The results obtained in Examples 5 to 8 are shown in Table 2.

TABLE 2

| | Example 5 | Example 6 | Example 7 | Example 8 |
|---|---|---|---|---|
| Fluororesin (A-2) | 100 | 80 | 80 | 80 |
| Soft resin (B-1) | — | 20 | — | — |
| Soft resin (B-2) | — | — | 20 | — |
| Soft resin (B-3) | — | — | — | 20 |
| Elastic modulus in | 480 | 350 | 380 | 360 |
| bending (MPa) | | | | |
| Flame retardancy | A | A | A | A |
| Processing or | A | A | A | A |
| processed ability | | | | |

A-2: Tetrafluoroethylene/hexafluoropropylene/perfluoro(propyl vinyl ether) copolymer (melting point: 210° C.)
B-1: E-600, product of Dow Corning Toray Silicone
B-2: DAI-EL G-701, product of Daikin Industries
B-3: SL-C, product of Chisso Corporation.

As shown in Table 2, the pellets and test specimens obtained in Examples 5 to 8 showed excellent processing or processed ability and flame retardancy in all the examples. In particular, the test specimens obtained in Examples 6 to 8 showed particularly excellent elastic moduli in bending.

### EXAMPLE 9

Test specimens were prepared from the fluororesin (A-3) by the method described above under (1) and subjected to elastic modulus in bending and flame retardancy evaluations. Further, the fluororesin (A-3) was evaluated for processing or processed ability by the method described above under (4) at a cylinder temperature of 300° C.

### EXAMPLES 10 TO 12

The fluororesin (A-3) was preliminarily blended with each of the soft resins (B) in the proportion shown in Table 3, and the mixture was melt-blended and pellets for cable jacketing were produced therefrom in the same manner as in Examples 2 to 4. From the pellets obtained, test specimens were prepared by the method described above under (1) and evaluated for elastic modulus in bending and for flame retardancy. Further, the pellets obtained were evaluated for processing or processed ability by the method described above under (4) at a cylinder temperature of 300° C.

The results obtained in Examples 9 to 12 are shown in Table 3.

TABLE 3

| | Example | Example | Example | Example |
|---|---|---|---|---|
| | 9 | 10 | 11 | 12 |
| Fluororesin (A-3) | 100 | 80 | 80 | 80 |
| Soft resin (B-1) | — | 20 | — | — |
| Soft resin (B-2) | — | — | 20 | — |
| Soft resin (B-3) | — | — | — | 20 |
| Elastic modulus in | 520 | 420 | 450 | 430 |
| bending (MPa) | | | | |
| Flame retardancy | A | A | A | A |
| Processing or | A | A | A | A |
| processed ability | | | | |

A-3: Tetrafluoroethylene/perfluoro(methyl vinyl ether) copolymer (melting point: 200° C.)
B-1: E-600, product of Dow Corning Toray Silicone
B-2: DAI-EL G-701, product of Daikin Industries
B-3: SL-C, product of Chisso Corporation.

As shown in Table 3, the pellets and test specimens obtained in Examples 9 to 12 showed excellent processing or processed ability and flame retardancy in all the examples. Further, the test specimens obtained in Examples 10 and 12 showed particularly excellent elastic moduli in bending.

### COMPARATIVE EXAMPLE 1

Test specimens were prepared from the fluororesin (C) by the method described above under (1) and evaluated for elastic modulus in bending and for flame retardancy. Further, the fluororesin (C) was evaluated for processing or processed ability by the method described above under (4).

### COMPARATIVE EXAMPLES 2 TO 4

Using the fluororesin (C) in lieu of the fluororesin (A-1), pellets were prepared by melt-blending in the same manner as in Examples 2 to 4.

Test specimens were prepared from the thus-obtained pellets by the method described above under (1) and evaluated for elastic modulus in bending and for flame retardancy. Further, the pellets obtained were evaluated for processing or processed ability by the method described above under (4).

The results of Comparative Examples 1 to 4 are shown in Table 4.

TABLE 4

| | Compara- | Compara- | Compara- | Compara- |
|---|---|---|---|---|
| | tive | tive | tive | tive |
| | Example 1 | Example 2 | Example 3 | Example 4 |
| Fluororesin (C) | 100 | 80 | 80 | 80 |
| Soft resin (B-1) | — | 20 | — | — |
| Soft resin (B-2) | — | — | 20 | — |
| Soft resin (B-3) | — | — | — | 20 |
| Elastic modulus in | 550 | 450 | 480 | 460 |
| bending (MPa) | | | | |
| Flame retardancy | A | A | A | A |
| Processing or | B | B | C | C |
| processed ability | | | | |

C: Tetrafluoroethylene/hexafluoropropylene copolymer (melting point: 260° C.)
B-1: E-600, product of Dow Corning Toray Silicone
B-2: DAI-EL G-701, product of Daikin Industries
B-3: SL-C, product of Chisso Corporation.

As shown in Table 4, the test specimens obtained in Comparative Examples 1 to 4 revealed inferior processing or processed ability of the pellets.

### INDUSTRIAL APPLICABILITY

The material for cable jackets according to the invention, which has the constitution described above, shows good processing or processed ability and can form cable jackets excellent in flexibility without any substantial deterioration of the flame retardancy which is shown by the cable jackets made of the conventional high-melting FEP alone.

The cable for LAN of the invention, which is having the cable jacket mentioned above, is excellent in flame retardancy and flexibility.

1. A material for cable jackets comprising a fluororesin (A),
wherein said fluororesin (A) shows a melting point at a temperature exceeding 180° C. but not higher than 245° C.

2. The material for cable jackets according to claim 1,
which is further mixed with a soft resin (B).

3. The material for cable jackets according to claim 1,
wherein the fluororesin (A) comprises a copolymer comprising tetrafluoroethylene and hexafluoropropylene, a copolymer comprising tetrafluoroethylene, hexafluoropropylene and a perfluoro(alkyl vinyl ether), or a copolymer comprising tetrafluoroethylene and a perfluoro(alkyl vinyl ether).

4. The material for cable jackets according to claim 2,
wherein the soft resin (B) is a silicone rubber, a fluororubber and/or poly(vinyl chloride).

5. The material for cable jackets according to claim 2,
which has a sea-island structure comprising fluororesin (A) as a sea component and the soft resin (B) as an island component.

6. The material for cable jackets according to claim 2,
wherein the soft resin (B) accounts for 1 to 70% by mass of the total mass of the fluororesin (A) and said soft resin (B).

7. The material for cable jackets according to claim 1,
which further comprises a flame retardant.

8. A cable jacket obtained by molding the material for cable jackets according to claim 1.

9. A cable for LAN having the cable jacket according to claim 8.
